(19) United States
(12) Patent Application Publication
(10) Pub. No.: US 2025/0067849 A1
(43) Pub. Date: Feb. 27, 2025

(54) SPATIAL LIGHT MODULATOR, METHOD OF MANUFACTURING THE SAME, AND LIDAR APPARATUS INCLUDING SPATIAL LIGHT MODULATOR

(71) Applicant: SAMSUNG ELECTRONICS CO., LTD., Suwon-si (KR)

(72) Inventors: Byunggil JEONG, Suwon-si (KR); Sunil KIM, Suwon-si (KR); Junghyun PARK, Suwon-si (KR); Minkyung LEE, Suwon-si (KR)

(73) Assignee: SAMSUNG ELECTRONICS CO., LTD., Suwon-si (KR)

(21) Appl. No.: 18/409,388

(22) Filed: Jan. 10, 2024

(30) Foreign Application Priority Data
Aug. 21, 2023 (KR) 10-2023-0109345

(51) Int. Cl. G01S 7/481; G02F 1/29

(52) U.S. Cl. CPC G01S 7/4817; G02F 1/29

(57) ABSTRACT

Provided are a spatial light modulator, a method of manufacturing the same, and a light detection and ranging (LiDAR) apparatus including the spatial light modulator. The spatial light modulator includes a substrate including an opening, and a plurality of pixels, wherein at least one pixel of the plurality of pixels includes a first reflective layer provided on the substrate, a cavity layer provided on the first reflective layer, and a second reflective layer provided on the cavity layer, the second reflective layer including a grating structure. The plurality of pixels are supported by the substrate and are arranged to be separated from each other.

### CROSS-REFERENCE TO RELATED APPLICATION

This application is based on and claims priority under 35 U.S.C. § 119 to Korean Patent Application No. 10-2023-0109345, filed on Aug. 21, 2023, in the Korean Intellectual Property Office, the disclosure of which is herein incorporated by reference in its entirety.

### BACKGROUND

### 1. Field

Example embodiments of the disclosure relate to an optical scanner that radiates incident light in a given direction, and more particularly, to a spatial light modulator, a method of manufacturing the same, and a light detection and ranging (LiDAR) apparatus including the spatial light modulator.

### 2. Description of the Related Art

A spatial light modulator (SLM) may be used as an optical scanner by adjusting a light emitting angle of incident light. Recently, an SLM using an active meta device has been introduced.

An SLM using an active meta device includes a meta surface, a distributed Bragg reflector (DBR) layer functioning as a mirror, and a cavity.

The meta surface of the SLM includes a plurality of high contrast gratings (HCGs). Both the HCG and the DBR layer have a high reflectivity for incident light, and thus vertical incident light may be amplified in the cavity and may be emitted vertically.

### SUMMARY

Provided are a reliable spatial light modulator, a light detection and ranging (LiDAR) apparatus including the spatial light modulator, and a method of manufacturing the spatial light modulator.

Additional aspects will be set forth in part in the description which follows and, in part, will be apparent from the description, or may be learned by practice of the presented embodiments of the disclosure.

According to an aspect of an example embodiment of the disclosure, a spatial light modulator includes: a substrate including an opening; and a plurality of pixels, wherein at least one pixel of the plurality of pixels includes a first reflective layer provided on the substrate, a cavity layer provided on the first reflective layer, and a second reflective layer provided on the cavity layer, the second reflective layer including a grating structure, wherein the plurality of pixels are supported by the substrate and are arranged to be separated from each other.

According to an aspect of an example embodiment of the disclosure, a LIDAR apparatus includes: a light source; a light modulator configured to adjust a travel direction of light emitted from the light source and radiate the light toward an object; and a photodetector configured to detect light reflected from the object, wherein the light modulator includes: a substrate including an opening; and a plurality of pixels provided on the substrate, at least one pixel of the plurality of pixels includes a first reflective layer, a cavity layer provided on the first reflective layer, and a grating structure provided on the cavity layer, and wherein the plurality of pixels are supported by the substrate and are arranged to be separated from each other.

According to an aspect of an example embodiment of the disclosure, a method of manufacturing a spatial light modulator includes: providing a first reflective layer on a substrate; providing a cavity layer on the first reflective layer; providing a second reflective layer on the cavity layer; providing a grating structure on the second reflective layer; forming a trench in a stack structure, the stack structure including the first reflective layer, the cavity layer, and the second reflective layer and providing at least one pixel; and forming an opening on the substrate, wherein each of pixels included in the spatial light modulator is supported by the substrate and are arranged to be separated from each other.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a spatial light modulator according to an embodiment;

FIG. 2 is a view illustrating a cross section of the spatial light modulator of FIG. 1;

FIG. 3 is a cross-sectional view showing a substrate and a pixel of a spatial light modulator according to an embodiment;

FIG. 4 is a view illustrating a structure of a pixel in a spatial light modulator according to an embodiment;

FIG. 5 shows a method of driving a spatial light modulator according to an embodiment;

FIG. 6 shows a method of driving a spatial light modulator according to an embodiment;

FIGS. 7 to 17 are cross-sectional views for explaining a method of manufacturing a spatial light modulator according to an embodiment; and

FIG. 18 is a schematic view for explaining an apparatus including a spatial light modulator according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. Expressions such as “at least one of,” when preceding a list of elements, modify the entire list of elements and do not modify the individual elements of the list.

Hereinafter, a spatial light modulator, and driving and manufacturing methods thereof according to example embodiments will be described in detail with reference to the accompanying drawings. In the following descriptions, the thickness of the layers or areas shown in the drawing may be somewhat exaggerated for the clarity of the specification. The embodiments described below are just an exemplary, and various variations are possible from these embodiments. In addition, in a layer structure described below, when an element is referred to as being “on” or “above” or “below” another element, the element may be directly on the other element or intervening elements may be present. In the description below, the same reference number of each drawing represents the same member.

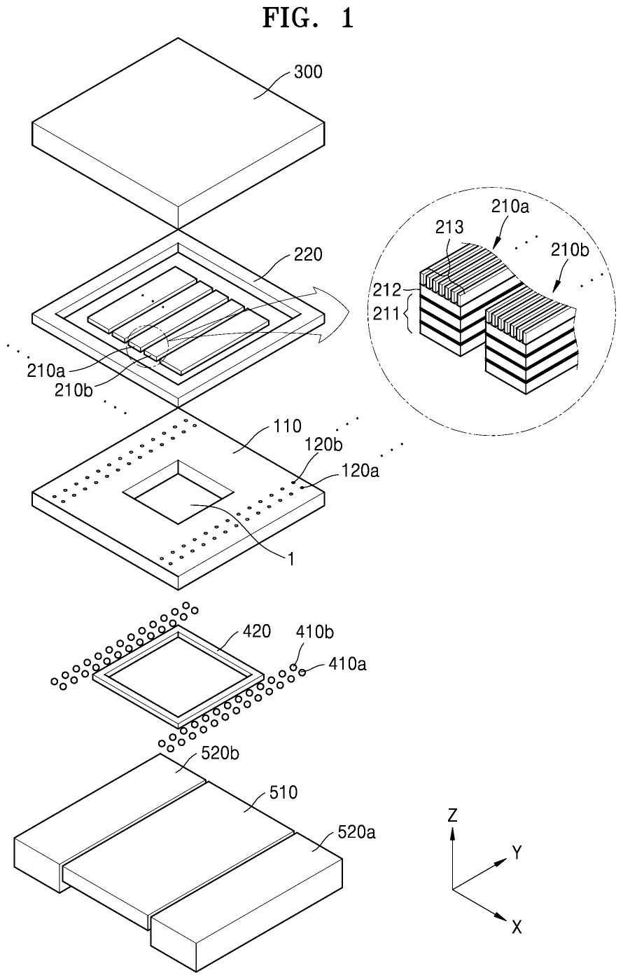

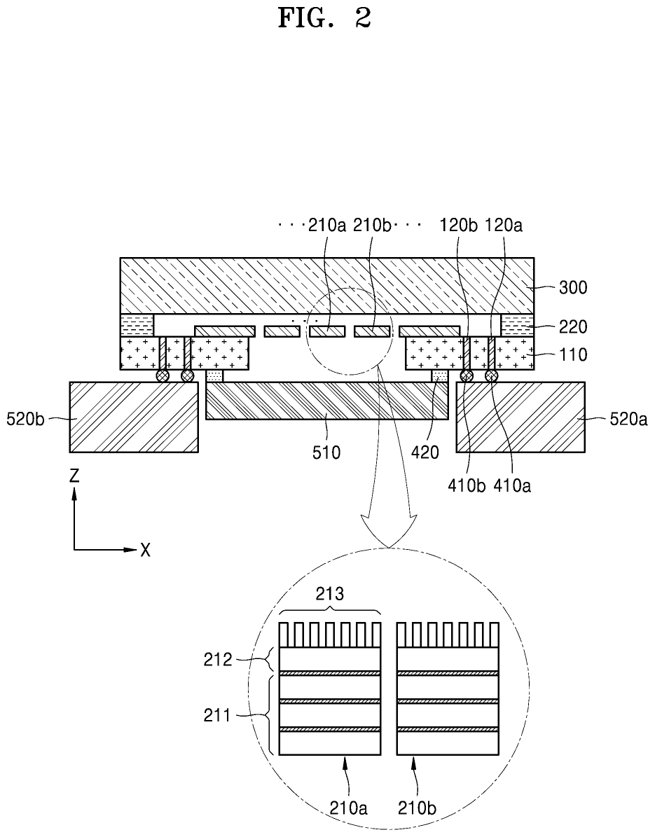

FIG. 1 is a view illustrating a spatial light modulator according to an embodiment, and FIG. 2 is a view illustrating a cross section of the spatial light modulator of FIG. 1.

Referring to FIGS. 1 and 2, a spatial light modulator according to an embodiment may include a substrate 110, at least one pixel, and a glass layer 300. The at least one pixel may include a first pixel 210a and a second pixel 210b.

A first surface of the substrate 110 may be provided on a plan defined by a first direction (e.g., X direction) and a second direction (e.g., Y direction). The substrate 110 may have a height in a third direction (e.g., Z direction). The substrate 110 may have a constant height in the third direction. The substrate 110 may include an opening 1. The opening 1 of the substrate 110 may be provided in the third direction (Z direction). The height of the opening 1 of the substrate 110 in the third direction (Z direction) may be the same as the height of the substrate 110. The opening 1 may be filled with air or other materials, or may maintain a vacuum state without any substance. In FIG. 1, a cross section of the opening 1 in the first direction (X direction) and the second direction (Y direction) are shown to be rectangular, but the opening 1 is not limited thereto, and the opening 1 may have a cross section having various shapes and sizes on a plan defined by the first direction (X direction) and the second direction (Y direction). For example, the substrate 110 may be a semiconductor substrate (e.g., silicon substrate) and is not limited thereto. The thickness of the substrate 110 may be determined in consideration of various factors. For example, the thickness of the substrate 100 may be determined in consideration of form factors, thermal discharge, and the like when a spatial light modulator is applied to a product.

The substrate 110 may include at least one through silicon via (TSV) electrode. The at least one TSV electrode may include a first TSV electrode 120a and a second TSV electrode 120b, but is not limited thereto. Each of the first and the second TSV electrodes 120a and 120b may be provided through the substrate 110 in the third direction (Z direction). The first and the second TSV electrodes 120a and 120b may be provided within an area of the substrate 110, which corresponds to an area inside a circumference of the glass layer 300. That is, areas of the TSV electrodes 120a and 120b on the plan defined by the first direction (X direction) and the second direction (Y direction) of the substrate 110 may be located inward than an area of the circumference of the glass layer 300 on the plan defined by the first direction (X direction) and the second direction (Y direction).

The substrate may support the first pixel 210a and the second pixel 210b. The first pixel 210a and the second pixel 210b may include a first reflective layer 211, a cavity layer 212, and a grating structure 213, which are sequentially stacked. The first reflective layer 211 may be a distributed Bragg reflector (DBR) layer. The first pixel 210a and the second pixel 210b may extend along a longitudinal direction, for example, in the second direction (Y direction), as shown in FIG. 1.

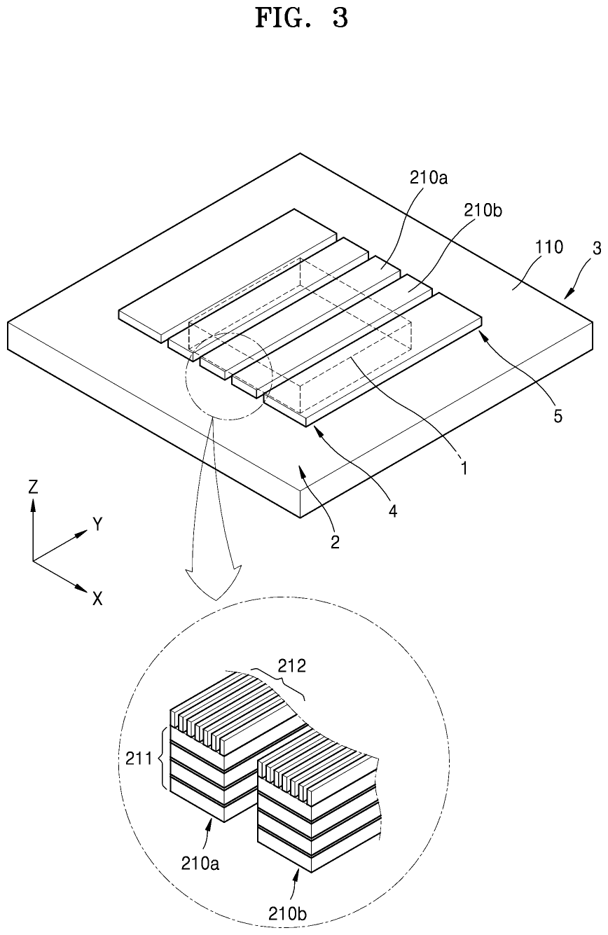

Each of the first and the second pixels 210a and 210b may be supported by a portion of the substrate 110 except for the opening 1. For example, one end 4 and the other end 5 of first and the second pixels 210a and 210b in a longitudinal direction may be provided on a first surface of the substrate 110 (see FIG. 3). For example, the end 4 and the other end 5 of the first and the second pixels 210a and 210b in the longitudinal direction may be provided at one end 2 and the other end 3 of the substrate 110, respectively (see FIG. 3). That is, the end 4 of the first pixel 210a may be provided at the end 2 of the substrate 110, and the other end 5 of the second pixel 210b may be provided at the other end 3 of the substrate 110. In addition, a center portion between the end 4 and the other end 5 of the first and the second pixels 210a and 210b may be provided on the opening 1 of the substrate 110. Thus, only a portion of each of the first and the second pixels 210a and 210b (e.g., the end 4 and the other end 5 in a longitudinal direction) may be in contact with one surface of the substrate 110, and another portion of each of the first and the second pixels 210a and 210b (e.g., the center portion in the longitudinal direction) may be provided on the opening 1 of the substrate 110 and may not be in contact with the substrate 110.

For example, the first surface of the substrate 110 on which the first and the second pixels 210a and 210b are provided may be an upper surface of the substrate 110, but may be a lower surface or a side surface of the substrate 110 according to a point of view from which the substrate 110 is viewed. In addition, the spatial light modulator according to an embodiment may further include other members.

The first and the second pixels 210a and 210b may be completely separated from each other. For example, the first reflective layer 211, the cavity layer 212, and the grating structure 213 included in the first and the second pixels 210a and 210b may be divided correspondingly to each of the first and the second pixels 210a and 210b, and the first and the second pixels 210a and 210b may be spaced apart from each other.

The glass layer 300 may be provided in the first direction (X direction) and the second direction (Y direction) on the first and the second pixels 210a and 210b. The first and the second pixels 210a and 210b may be provided between the substrate 110 and the glass layer 300. A first bond 220 may be provided between the substrate 110 and the glass layer 300. The first bond 220 may be provided along the circumference of the glass layer 300. The first bond 220 may be provided outside an area including the first and the second pixels 210a and 210b in the first direction (X direction) and the second direction (Y direction). The first bond 220 may include a metal (e.g., gold (Au) or aluminum (Al)). Alternatively, the first bond 220 may include silicon (Si) or silicon dioxide (SiO₂).

A protective layer 510 may be provided on a second surface of the substrate 110. A second bond 420 may be provided along a circumference of the protective layer 510 between the substrate 110 and the protective layer 510. The second bond 420 may include a metal.

At least one control board may be provided to be spaced apart from the protective layer 510 on the second surface of the substrate 110. For example, the at least one control board may include a first control board 520a and a second control board 520b, but is not limited thereto. A thickness of the at least one control board 520a or 520b in the third direction (Z direction) may be larger than a thickness of the protective layer 510 in the third direction (Z direction). Alternatively, a thickness of the at least one control board 520a or 520b in the third direction (Z direction) may be equal to a thickness of the protective layer 510 in the third direction (Z direction). Alternatively, a thickness of the at least one control board 520a or 520b in the third direction (Z direction) may be smaller than a thickness of the protective layer 510 in the third direction (Z direction). A solder ball 410a or 410b may be provided between the at least one control board 520a or 520b and the at least one TSV electrode 120a or 120b.

For example, the second surface of the substrate 110 may be a lower surface of the substrate 110 but may be an upper surface or a side surface according to a point of view from which the substrate 110 is viewed.

FIG. 3 is a cross-sectional view showing a substrate and a pixel of a spatial light modulator according to an embodiment.

As shown in FIG. 3, each of the first and the second pixels 210a and 210b may be supported by a portion of the substrate 110 except for the opening 1 of the substrate 110, and each of the pixels 210a and 210b may be completely separated from each other.

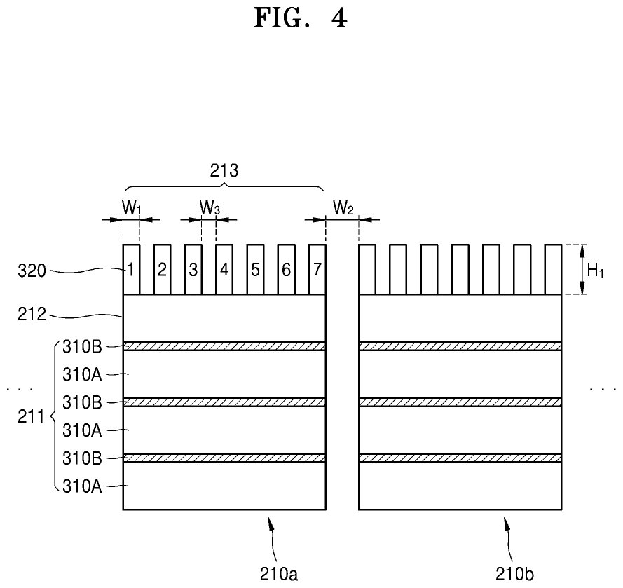

FIG. 4 is a view illustrating a structure of a pixel according to an embodiment.

Referring to FIG. 4, each of the first and the second pixels 210a and 210b may include the first reflective layer 211, the cavity layer 212, and the grating structure 213.

For example, the first reflective layer 211 may include a plurality of first layers 310A and a plurality of second layers 310B that are repeatedly and alternately stacked in a perpendicular direction on one surface of the substrate 110. The first and the second layers 310A and 310B may have different thermal conductivities and refractive indexes. A thermal conductivity of the first layer 310A may be lower than a thermal conductivity of the second layer 310B. For example, the first layer 310A may include a silicon oxide layer, but is not limited thereto. For example, the second layer 310B may be a semiconductor layer, for example, a silicon (Si) layer, but is not limited thereto. A thickness of the lowermost first layer 310A of the first reflective layer 211, which is in direct contact with the one surface of the substrate 110, may be different from a thickness of another first layer 310A of the first reflective layer 211 that is not in direct contact with the one surface of the substrate 110. For example, the thickness of the lowermost first layer 310A may be larger than the thickness of the other first layer 310A. The thicknesses of the other first layers 310A except for the lowermost first layer 310A may be the same or may be substantially the same as each other.

In FIG. 4, the first and the second layers 310A and 310B are shown to be repeatedly and alternately stacked three times, but the first and the second layers 310A and 310B may be repeatedly and alternately stacked less than three times or more than three times. In the first reflective layer 211, an uppermost layer of the first reflective layer 211 may be the second layer 310B and may be in direct contact with the cavity layer 212.

The cavity layer 212, which resonates and amplifies incident light between the first reflective layer 211 and the grating structure 213, may be a single layer. The cavity layer 212 may include a material layer with a low thermal conductivity. For example, a thermal conductivity of the cavity layer 212 may be lower than a thermal conductivity of the second layer 310B of the first reflective layer 211. For example, the cavity layer 212 may include a silicon oxide layer, but is not limited thereto. A thickness of the cavity layer 212 may be changed depending on a wavelength of incident light. For example, the cavity layer 212 may have a thickness λ/3 corresponding to 1/3 of a wavelength λ of incident light, but is not limited thereto. For example, a thickness of the cavity layer 212 may be smaller or larger than λ/3. For example, when a wavelength λ of incident light is 1550 nm, the cavity layer 212 may be designed to allow optimal resonance in a thickness of about 500 nm to about 600 nm.

The grating structure 213 may include a plurality of active high contrast gratings (HCGs) 320. The shapes and dimensions of the plurality of HCGs may be the same or substantially the same as each other. A width W₁ and a height H₁ of each HCG may be smaller than a wavelength of incident light. The height H₁ of each HCG may be designed to have a high reflectivity for incident light, and for example, may be designed to have a reflectivity of 70% or more. The plurality of HCGs may be arranged in one-dimension (1D). For example, the plurality of HCGs may be arranged in a row. A spacing at which the plurality of HCGs are arranged may be shorter than a wavelength of incident light. In this regard, the grating structure 213 may be referred to as an active meta surface or an active meta surface layer, and each HCG may be referred to as an active meta pattern or an active meta diffraction pattern. A material of each HCG may be, but is not limited to, crystalline silicon.

For example, each grating structure 213 of the pixel 210a or 210b may include at least one high contrast grating (HCG) 320. For example, the pixel 210a may include, but is not limited to, first to seventh HCGs 1 to 7. The pixel 210a may include less than or greater than seven HCGs. For example, each of the pixels 210a and 210b may include, but are not limited to, the first to the seventh HCGs 1 to 7. A spacing W₃ between the HCGs 1 to 7 included in the pixels 210a and 210b may be the same or substantially the same as each other. The spacing W₃ between the HCGs 1 to 7 included in the pixels 210a and 210b may be smaller than a spacing W₂ between the pixels 210a and 210b.

Although not shown, upper and lower ends of each of the HCGs 1 to 7 included in the pixels 210a and 210b may each be a doping area. For example, the doping area may be an area doped with an n-type or p-type dopant. Accordingly, a current may flow through each of the HCGs 1 to 7.

When a current is applied to each of the HCGs 1 to 7, Joule heat may be generated due to internal resistance of each of the HCGs 1 to 7 to increase a temperature of a corresponding HCG. According to such a change in temperature, a refractive index of each of the HCGs 1 to 7 and a reflectivity for incident light may be sequentially changed.

According to this principle, the plurality of HCGs 1 to 7 are used as one pixel to form a modulation unit, and when a current is applied to some pixels according to a certain current application pattern, an angle of emitted light (primary reflected light) may be adjusted. Therefore, beam scanning may be performed by changing a current application pattern.

The first reflective layer 211 and the cavity layer 212 may be divided correspondingly to each grating structure 213. That is, the first reflective layer 211 and the cavity layer 212 may be divided correspondingly to the number of the plurality of grating structures 213. Accordingly, the grating structure 213 including the plurality of grating structures 213 and the stacked first reflective layer 211 and cavity layer 212 may correspond one-to-one to each other. In other words, one grating structure 213 may be present on the divided one cavity layer 212. However, this is merely an example embodiment and the disclosure is not limited thereto.

Hereinafter, a method of driving the spatial light modulator (or operation method) according to example embodiments will be described.

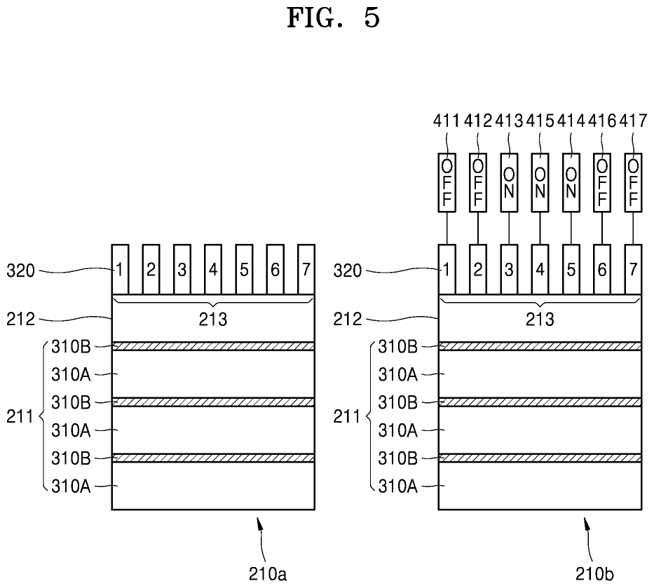

FIG. 5 shows a first driving method of a spatial light modulator according to an embodiment. The first driving method may be a driving method of the aforementioned spatial light modulator(s).

In the first driving method of FIG. 5, the first pixel 210a is considered as a non-driving pixel and the second pixel 210b is considered as a driving pixel. This example is used in this embodiment as well as other driving methods according to example embodiments that will be described below.

Referring to FIG. 5, a current is applied only to at least one or some HCGs of the first to the seventh HCGs 1 to 7 included in the second pixel 210b, and a current is not applied to the other HCGs. For example, a current is applied only to the third to fifth HCGs 3, 4, and 5, and a current is not applied to the first and the second HCGs 1 and 2 and the sixth and the seventh HCGs 6 and 7. For example, a current of about 7 mA may be applied to the third to the fifth HCGs 3, 4, and 5, but the disclosure is not limited thereto.

Such current application may be controlled by current controllers 411 to 417 that are respectively connected to the first to the seventh HCGs 1 to 7 included in the second pixel 210b. For example, the current controllers 413 to 415 connected to the third to the fifth HCGs 3, 4, and 5 may be in an on-state, and the current controllers 411 to 412 and 416 to 417 connected to the first and the second HCGs 1 and 2 and the sixth and the seventh HCGs 6 and 7 may be in an off-state. Although current controllers are separately connected to each of the pixels 210a and 210b, only the current controllers 411 to 417 connected to one driving pixel 210b are illustrated for convenience of illustration.

As such, among the HCGs 1 to 7 included in the driving pixel 210b, a current is applied only to an HCG in an inner area of the grating structure 213 without applying a current to an HCG at an outer area (or an edge) of the grating structure 213, and thus transmission of heat generated in the driving pixel 210b to an adjacent non-driving pixel 210a may be minimized or blocked.

A current may be applied to the first and the second pixels 210a and 210b using a binary driving method. For example, the first and the second pixels 210a and 210b may be aligned in one direction (one-dimensionally aligned), and may be aligned alternately and repeatedly. In this alignment, the first pixel 210a may be selected as a non-driving pixel and the second pixel 210b may be selected as a driving pixel, and thus the grating structure 213 may be driven to be alternately and repeatedly on/off. A current application to the second pixel 210b is performed in a manner such that a current may not be applied to several HCGs adjacent to the first pixel 210a at both sides among the HCG included in the second pixel 210b, and a current may be applied only to the remaining HCGs that are not adjacent to the first pixel 210a.

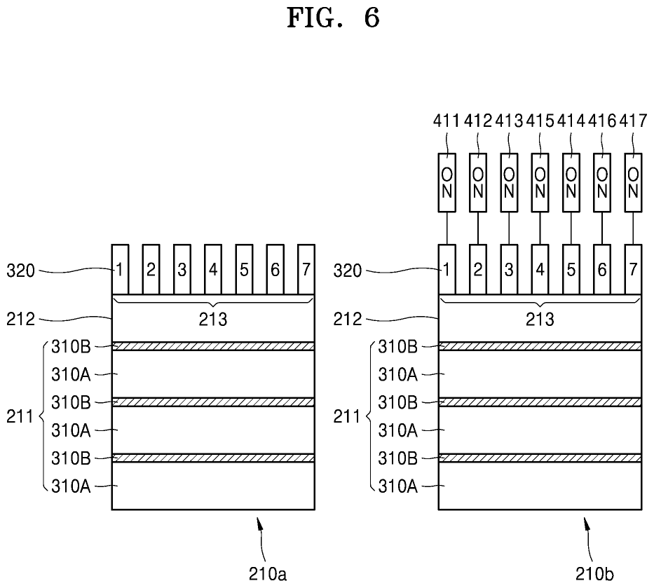

FIG. 6 shows a second driving method of a spatial light modulator according to an embodiment. The above-described spatial light modulator is described as an example, and only a difference from the first driving method will be described.

Referring to FIG. 6, in the second driving method, a current is applied to all of the first to the seventh HCGs 1 to 7 included in the second pixel 210b, which is a driving pixel. In this case, the current controllers 411 to 417 may be all in an on-state. A current is applied to all of the HCGs 1 to 7 included in the second pixel 210b, and in this case, temperature distribution of the second pixel 210b may be uniform as a whole.

Even if a current is applied to the second pixel 210b, that is, all of the HCGs 1 to 7 included in the second pixel 210b, transmission of heat to the non-driving pixel 210a from the driving pixel 210b may be minimized or blocked.

The spatial light modulator according to the above-described embodiment may be provided as an apparatus to be used in itself, but may be used as components or devices that make up different apparatuses.

The space light modulator according to an embodiment may be applied to devices in various fields, and for example, may be applied to a scanner that is used in a time of flight (ToF) sensor for a light detection and ranging (LiDAR), a motion recognition sensor, a depth sensor, and an authentication sensor, which include a beam scanner. In an embodiment, the LiDAR may be applied to a mobile device, and the space light modulator may be mounted on a mobile or wearable device that requires surrounding recognition by further using reduction in power consumption and form factor.

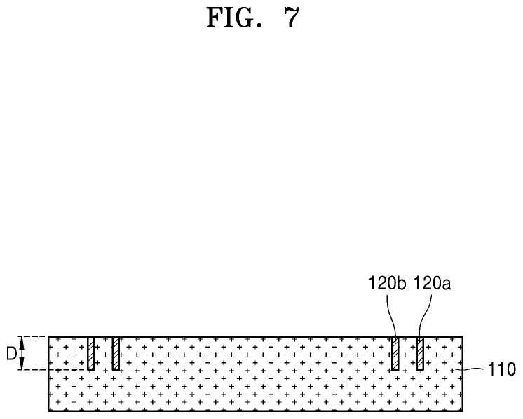

Hereinafter, a method of manufacturing a spatial light modulator according to an embodiment will be described with reference to FIGS. 7 to 17. The same reference number as the reference number mentioned in the spatial light modulator according to the above-described embodiments may denote the same or similar member, and a description thereof is omitted.

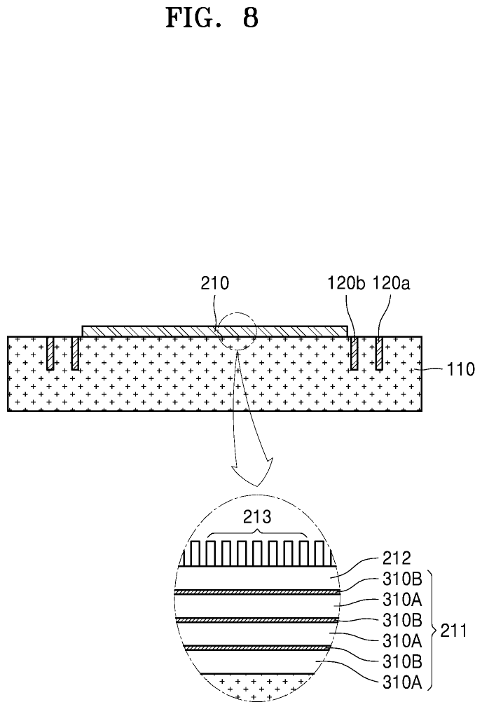

First, as shown in FIG. 7, the TSV electrodes 120a and 120b disposed in the substrate 110 may be formed. A thickness D of each of the TSV electrodes 120a and 120b may be smaller than a thickness of the substrate 100. Then, as shown in FIG. 8, after the TSV electrodes 120a and 120b are formed in the substrate 110, a stack structure 210 formed by sequentially stacking the first reflective layer 211, the cavity layer 212, and the grating structure 213 may be provided on the substrate 110. The stack structure 210 may be provided to cover a portion of one surface (e.g., upper surface) of the substrate 110.

The first reflective layer 211 may be formed by repeatedly and alternately stacking the first layer 310A and the second layer 310B, and for example, the first reflective layer 211 may be formed by repeatedly and alternately stacking the first layer 310A and the second layer 310B three times. The number of alternating repetitions may be greater than three or less than three. The first layer 310A of the first reflective layer 211, which is initially formed on the substrate 110, may be formed with a different thickness from a thickness of the other first layer 310A included in the first reflective layer 211. For example, a thickness of the first layer 310A, which is initially formed, may be larger than a thickness of the other first layer 310A. Alternatively, for example, the first layer 310A of the first reflective layer 211, which is initially formed on the substrate 110, that is, the lowermost first layer 310A of the first reflective layer 211 may be formed to have the same thickness or substantially the same thickness as a thickness of the other first layer 310A included in the first reflective layer 211.

The grating structure 213 may be stacked on an upper surface of the cavity layer 212. Portions of the grating structure 213 may be spaced apart from each other. Each grating structure 213 may include the plurality of active HCGs 1 to 7. However, the number of active HCGs included in each grating structure 213 is not limited to seven, and each grating structure 213 may include greater than seven or less than seven active HCGs. The plurality of active HCGs 1 to 7 may be the same or substantially the same as each other in all aspects such as a shape, a configuration, a function, and a material. The plurality of HCGs 1 to 7 included in each grating structure 213 are spaced apart from each other, and a spacing distance between the plurality of HCGs may be less than the width W₁ of each of the HCGs 1 to 7. The plurality of HCGs 1 to 7 included in each grating structure 213 may each be electrically driven and may be an active meta pattern. Thus, the grating structure 213 may be a meta surface or meta surface layer including a plurality of active meta patterns.

The meta surface may be formed by depositing a meta material layer on the upper surface of the cavity layer 212, and then patterning the deposited meta material layer. For example, the patterning of the deposited meta material layer may be performed using a photolithography process of a semiconductor manufacturing process, but the disclosure is not limited thereto.

In the forming of the grating structure 213, portions of each grating structure 213 may be spaced apart from each other, but a spacing distance of the portions of the grating structure 213 may be smaller than a spacing at which the active HCGs 1 to 7 included in each grating structure 213 are aligned and may be greater than the width of each of the HCGs 1 to 7.

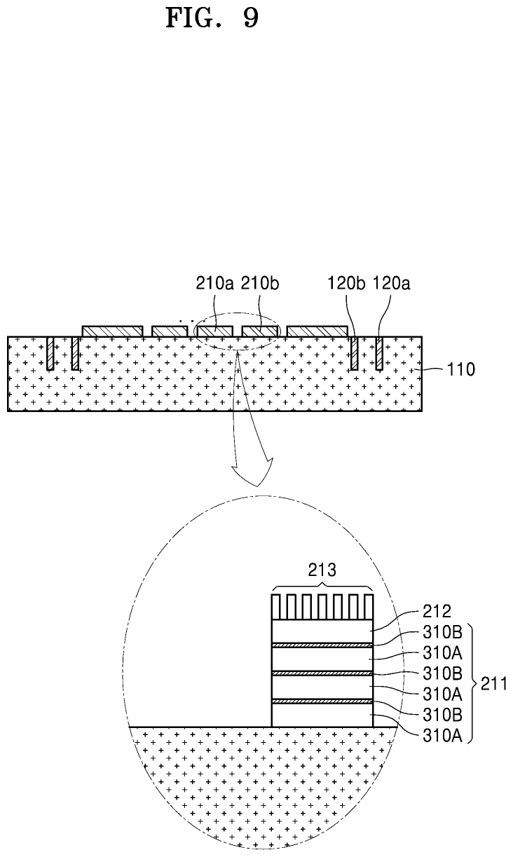

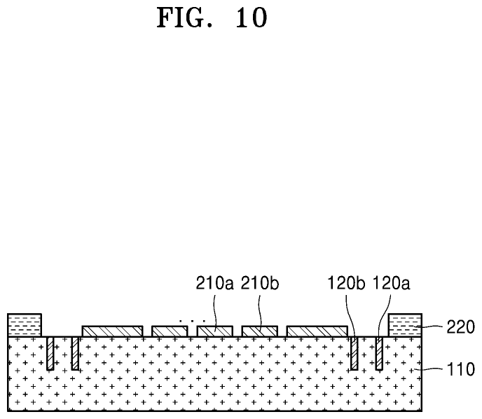

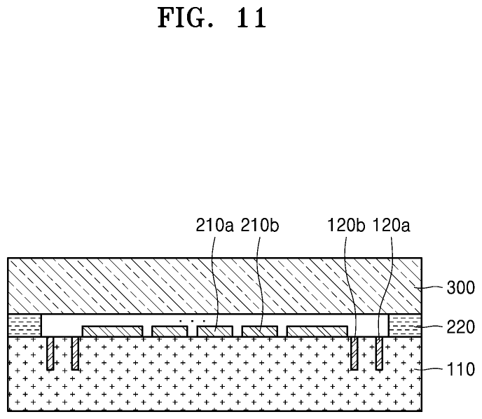

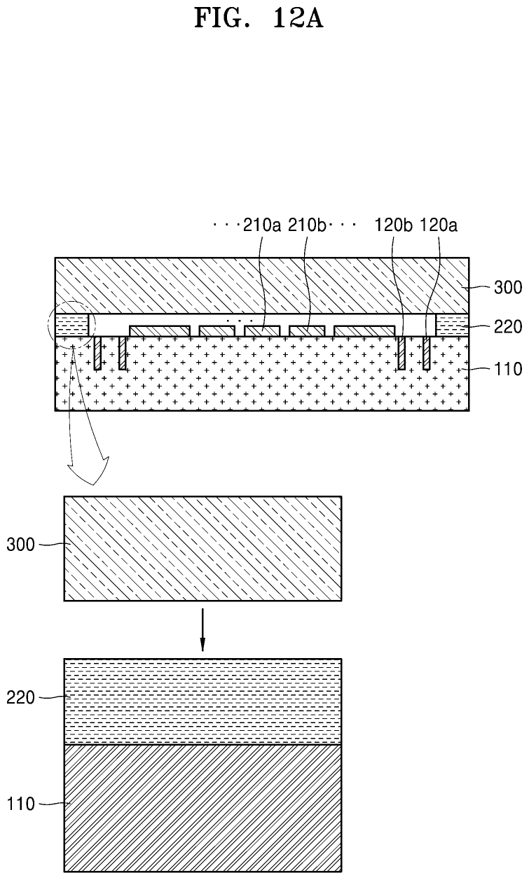

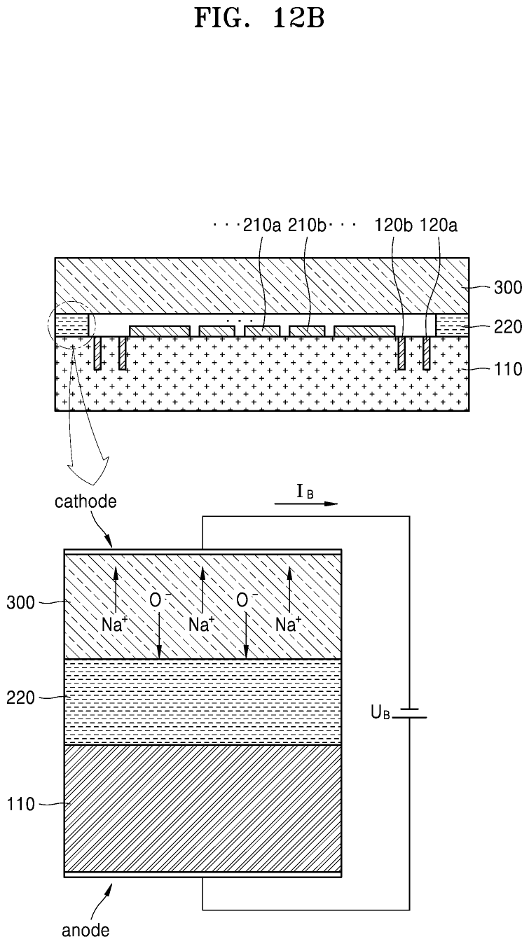

Then, as shown in FIG. 9, a trench through which one surface of the substrate 110 is exposed may be formed on the stack structure 210 of FIG. 9. The trench may be spaced apart from each grating structure 213. The trench may be spaced apart from the HCGs 1 to 7 included in each grating structure 213. The trench may be formed by sequentially etching the cavity layer 212 and the first reflective layer 211 in a state in which each grating structure 213 is masked, and the plurality of pixels 210a and 210b may be formed by performing etching. The aforementioned etching may be performed until the substrate 110 is exposed. For the aforementioned etching, a suitable method may be selected in consideration of a width and a depth of the trench to be formed. Then, as shown in FIG. 10, the first bond 220 may be formed along a circumference of one surface of the substrate 110. In an embodiment, as described above with reference to FIG. 1, the first bond 220 may include a metal (e.g., gold (Au) or aluminum (Al)). Alternatively, the first bond 220 may include silicon (Si) or SiO₂. Then, as shown in FIG. 11, the glass layer 300 may be provided on the first bond 220. Here, as shown in FIG. 12A, the substrate 110 and the glass layer 330 may be coupled to each other using, for example, an eutectic bonding method of adhering glass and silicon to each other using a metal thin film with a low melting point as an intermediate material. In this case, the first bond 220 may include a metal (e.g., gold (Au) or an aluminum (Al)). Alternatively, as shown in FIG. 12B, the substrate 110 and the glass layer 300 may be coupled to each other via anodic bonding of coupling the substrate 110 and the glass layer 300 to each other by applying a voltage between the substrate 110 as an anode and the glass layer 300 as a cathode and forming SiO₂ from O²⁻ of the glass layer 300 and Si of the substrate 110.

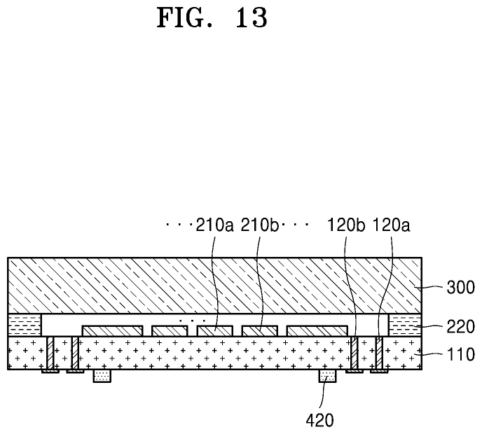

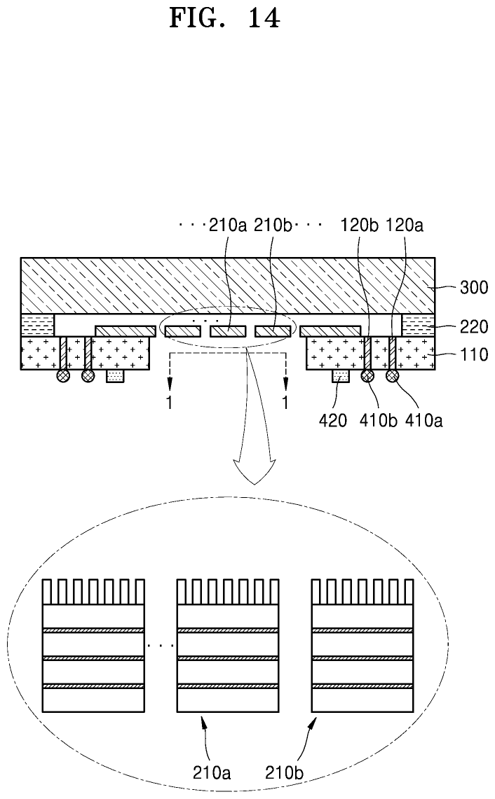

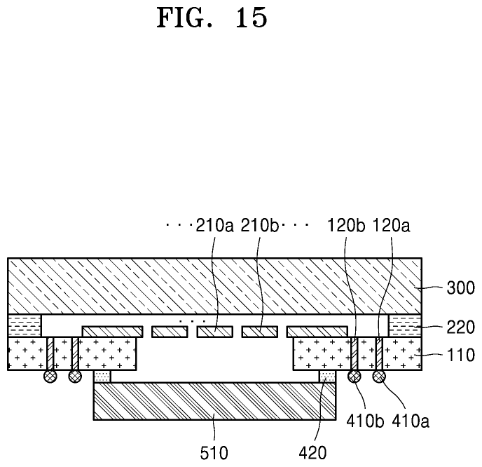

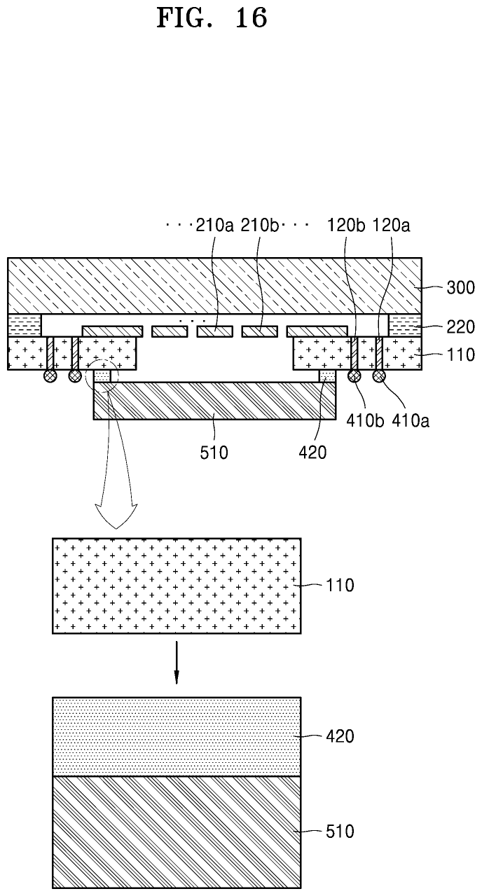

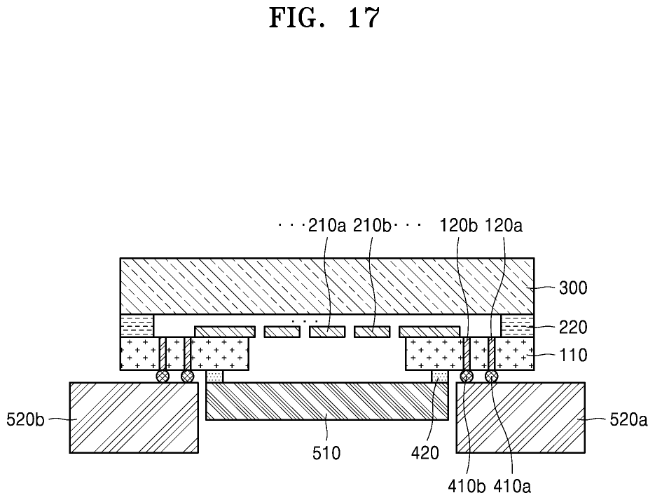

Then, as shown in FIG. 13, a lower portion of the substrate 110 may be removed, and the second bond 420 may be formed on the substrate 110, the lower portion of which is removed. The lower portion of the substrate 110 may be removed such that a height of the substrate 110 is similar to a height of each of the TSV electrodes 120a and 120b. Then, as shown in FIG. 14, a portion of the substrate 110 may be etched to form the opening 1. A portion of the substrate 110 may be etched such that the first and the second pixels 210a and 210b are supported by a portion, except for the opening 1, of the substrate 110. For example, one end and the other end of the first and the second pixels 210a and 210b in a longitudinal direction may be provided at one end and the other end of the substrate 110, respectively, and the opening 1 may be formed such that a center portion between one end and the other end of the first and the second pixels 210a and 210b is disposed on the opening 1 of the substrate 110. Then, as shown in FIG. 15, solder balls 410a and 410b may be provided below the TSV electrodes 120a and 120b, respectively, and the protective layer 510 may be provided below the second bond 420. Here, as shown in FIG. 16, the substrate 110 and the protective layer 510 may be coupled to each other via eutectic bonding of adhering glass and silicon using a metal thin film with a low melting point as an intermediate material. Then, as shown in FIG. 17, the control boards 520a and 520b may be provided below the solder balls 410a and 410b. As described above with reference to FIG. 1, the second bond 420 may include a metal (e.g., gold (Au) or an aluminum (Al)).

For example, the opening 1 may be filled with air or in a vacuum, or may be filled with a material for substantially reducing or blocking transmission of heat from a driving pixel to a non-driving pixel due to a low thermal conductivity.

A portion of the pixels 210a and 210b may be provided on the opening 1 of the substrate 110, and the pixels 210a and 210b may be supported by a portion, except for the opening 1, of the substrate 110, thereby reducing an area in contact with the substrate 110. The pixels 210a and 210b may be completely separated from each other. Thus, heat generated in the pixels 210a and 210b may be prevented from being transferred to adjacent pixels, and thus crosstalk performance of the spatial light modulator may be improved.

The protective layer 510 may be provided below the substrate 110, and the control boards 520a and 520b may be provided to be spaced apart from the protective layer 510, thereby achieving an effect of protecting and cooling the spatial light modulator.

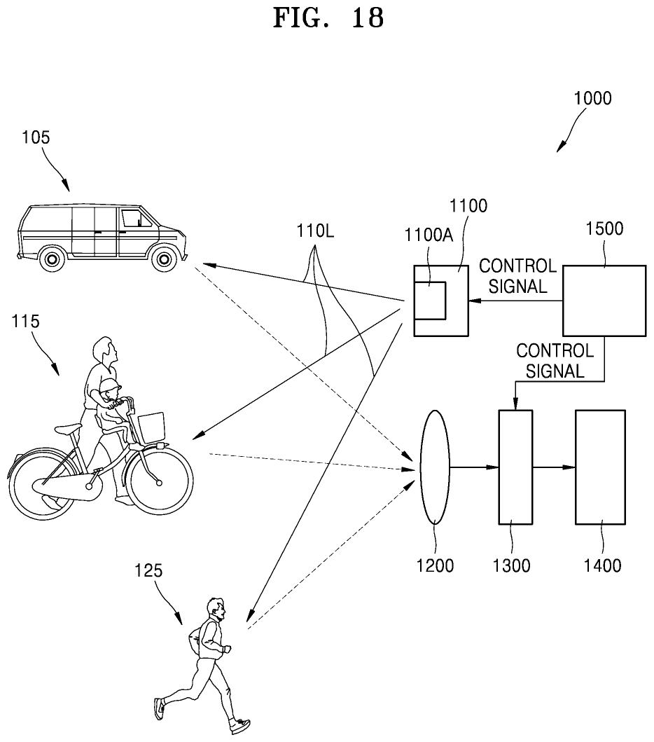

FIG. 18 schematically shows a LIDAR system 1000 as an example of an apparatus to which a spatial light modulator according to an embodiment is applied.

Referring to FIG. 18, the LiDAR system 1000 includes a light emitter 1100, a lens unit 1200, an optical filter unit 1300, a detector 1400, and a controller 1500. The LiDAR system 1000 may further include, in addition to the above components, other components as needed to acquire and process information for a first subject to a third subject 105, 115, and 125. Light may be emitted from the light emitter 1100 toward the subjects 105, 115, and 125 to detect and recognize the subjects 105, 115, and 125.

The number and shapes of the subjects 105, 115, and 125 shown in FIG. 18 are given as examples only and do not limit the disclosure. Various subjects may be detected by using the LiDAR system 1000, and the subjects may include a stationary or moving object that can reflect light emitted thereto.

Light 110L emitted toward the subjects 105, 115, and 1125 from the light emitter 1100 may be light falling within an infrared region, but is not limited thereto and any light may be used. When the subject is a human, light that is not harmful to a human body may be used.

The light emitter 1100 may include a light source module 1100A. The light source module 1100A may include a light source that generates light and an optical scanner provided to receive light emitted from the light source and radiate light toward the subjects 105, 115, and 125. The optical scanner may include one of the spatial light modulators according to aforementioned embodiment(s). The light source may be a light source that emits light with various wavelengths, for example, a laser beam, depending on a given light emission signal. The light source may include, for example, a Si photonics optical phase array (OPA) including a plurality of unit light sources (or cell light sources). A wavelength of the light 110L emitted from the light source module 1100A may be controlled according to a control signal provided from the controller 1500. The control signal may include a light emission signal. The light 110L emitted from the light source module 1100A is reflected from the subjects 105, 115, and 125 and is incident on the lens unit 1200.

The lens unit 1200 is shown as a single lens, but may be a lens optical system that includes a plurality of lenses and converges incident light to the optical filter unit 1300. Light incident on the lens unit 1200 is converged by the lens unit 1200 and incident on the optical filter unit 1300.

The optical filter unit 1300 may perform an operation of transmitting only light with a certain wavelength or light with a wavelength belonging to a certain band therethrough and blocking the other light. The optical filter unit 1300 may be provided to actively perform the operation. To this end, the optical filter unit 1300 may include an active device that transmits only light with a certain center wavelength therethrough and blocks light with other wavelengths in response to a control signal provided by the controller 1500. The control signal provided to the optical filter unit 1300 may include information on the center wavelength of the light to be transmitted through the active device, and the center wavelength indicated by the information corresponds to a center wavelength of light emitted from the light emitter 1100.

As a result, the control signal provided to the optical filter unit 1300 may include a control signal that matches a center wavelength of the light emitted from the light emitter 1100 and a center wavelength of light to be transmitted through the active device of the light filter unit 1300. The control signal provided to the optical filter unit 1300 from the controller 1500 may be provided in real time along with a control signal provided to the light emitter 1100 from the controller 1500. Therefore, the center wavelength of the light 100L emitted from the light emitter 1100 and the center wavelength of light to be transmitted through the active device may be controlled in real time through the controller 1500. This means that scanning for a scan area including the subjects 105, 115, and 125 of the LiDAR system 1000 according to an embodiment may be performed in real time.

The active device included in the optical filter portion 1300 may selectively transmit only desired light of the light filter unit 1300, and block other noise light in addition to natural light. Therefore, a signal-to-noise ratio (S/N) of the LiDAR system 1000 may be increased. As an example of the active device, the optical filter unit 1300 may include a tunable band pass filter. The operation method of the tunable band pass filter may be a liquid crystal or acousto-optic method.

Light transmitted through the optical filter unit 1300 is incident on the detector 1400. The detector 1400 senses light provided from the optical filter unit 1300 and obtains various information about the subjects 105, 115, and 125 based on information included in the light. For example, the detector 1400 may detect time delay or phase difference information from the incident light, and based thereon, the detector 1400 may obtain distance information from the subjects 105, 115, and 125, location information of the subjects 105, 115, and 125, and depth images of the subjects 105, 115, and 125. To this end, the detector 1400 may include a time to digital converter (TDC), an image sensor, and the like.

The controller 1500 may be disposed between the light emitter 1100 and the optical filter unit 1300, either physically or electrically. The controller 1500 controls operations of the light emitter 1100 and the optical filter unit 1300. The controller 1500 transmits a light emission start signal to the light emitter 1100 to emit light with a certain wavelength. In other words, the controller 1500 determines a wavelength of light to be emitted, transmits a control signal including information on an electrical signal for emitting light with the determined wavelength to the light emitter 1100, and allow the light emitter 1100 to emit light with the determined wavelength from the light source module 1100A. The controller 1500 transmits a light emission start signal to the light emitter 1100, and simultaneously, also transmits a control signal to the optical filter unit 1300 to control the optical filter unit 1300 such that a center wavelength of light transmitted through the optical filter unit 1300 corresponds to a wavelength of light emitted from the light emitter 1100. Many details are given in the above description, but these need to be interpreted as an example of an embodiment rather than limiting the scope of the disclosure. Therefore, the scope of the disclosure is not be determined by the described embodiment(s), but needs to be determined by the technical spirit described in the claims.

In the disclosed spatial light modulator, pixels may be completely separated from each other, and each pixel may be supported by a substrate including an opening. The opening may maintain a vacuum or may be filled with air or a material having a lower heat transfer rate than the substrate, the DBR layer, and the cavity layer included in the spatial light modulator, thereby minimizing or blocking transmission of heat generated in a driving pixel to a non-driving pixel.

Accordingly, independence in operating the driving pixel and the non-driving pixel may be increased, and a temperature difference between the driving pixel and the non-driving pixel is larger than the existing spatial light modulator, and thus emitted light may be focused precisely on a desired point. In addition, the output quality and efficiency of the spatial light modulator may be increased.

It should be understood that example embodiments described herein should be considered in a descriptive sense only and not for purposes of limitation. Descriptions of features or aspects within each embodiment should typically be considered as available for other similar features or aspects in other embodiments. While one or more example embodiments have been described with reference to the figures, it will be understood by those of ordinary skill in the art that various changes in form and details may be made therein without departing from the spirit and scope as defined by the following claims and their equivalents.

What is claimed is:

1. A spatial light modulator comprising:
a substrate including an opening; and
a plurality of pixels, wherein at least one pixel of the plurality of pixels includes a first reflective layer provided on the substrate, a cavity layer provided on the first reflective layer, and a second reflective layer provided on the cavity layer, the second reflective layer including a grating structure,
wherein the plurality of pixels are supported by the substrate and are arranged to be separated from each other.

2. The spatial light modulator of claim 1, further comprising
a glass layer provided on the substrate.

3. The spatial light modulator of claim 1, further comprising:
a protective layer provided on or below the substrate; and
at least one control board provided on or below the substrate, and spaced apart from the protective layer.

4. The spatial light modulator of claim 3,
wherein a thickness of the at least one control board is larger than a thickness of the protective layer.

5. The spatial light modulator of claim 3, further comprising:
a through silicon via (TSV) electrode provided in the substrate; and
a solder ball provided between the TSV electrode and the at least one control board.

6. The spatial light modulator of claim 1, further comprising:
a glass layer provided on the substrate;
a protective layer provided on or below the substrate;
a first bond provided along a circumference of the glass layer and between the substrate and the glass layer; and
a second bond provided along a circumference of the protective layer and between the substrate and the protective layer,
wherein the first bond includes a metal or SiO₂, and the second bond includes a metal.

7. The spatial light modulator of claim 6, further comprising:
a through silicon via (TSV) electrode provided on a first area of the substrate, the first area corresponding to a second area of the glass layer that is inside the circumference of the glass layer.

8. The spatial light modulator of claim 1,
wherein the first reflective layer includes:
a plurality of first layers having a relatively low thermal conductivity; and
a plurality of second layers having a relatively high thermal conductivity,
wherein the plurality of first layers and the plurality of second layers are repeatedly and alternately stacked; and
wherein a lowermost layer of the plurality of first layers is thicker than remaining first layers of the plurality of first layers.

9. The spatial light modulator of claim 1,
wherein the grating structure includes a plurality of high contrast gratings (HCGs).

10. The spatial light modulator of claim 1,
wherein the plurality of pixels include:
a driving pixel; and
a non-driving pixel; and
wherein the driving pixel and the non-driving pixel are driven according to a binary driving method.

11. A light detection and ranging (LiDAR) apparatus comprising:
a light source;
a light modulator configured to adjust a travel direction of light emitted from the light source and radiate the light toward an object; and
a photodetector configured to detect light reflected from the object,
wherein the light modulator comprises:
a substrate including an opening; and
a plurality of pixels provided on the substrate, at least one pixel of the plurality of pixels includes a first reflective layer, a cavity layer provided on the first reflective layer, and a grating structure provided on the cavity layer, and
wherein the plurality of pixels are supported by the substrate and are arranged to be separated from each other.

12. The LiDAR apparatus of claim 11, wherein the light modulator further comprises:
a through silicon via (TSV) electrode provided in the substrate;
a protective layer provided on or below the substrate;
at least one control board provided on or below the substrate and spaced apart from the protective layer; and
a solder ball provided between the TSV electrode and the at least one control board.

13. The LiDAR apparatus of claim 11, wherein the light modulator further comprises:
a glass layer provided on the substrate;
a protective layer provided on or below the substrate,
a first bond provided along a circumference of the glass layer and between the substrate and the glass layer; and
a second bond provided along a circumference of the protective layer and between the substrate and the protective layer,
wherein the first bond includes a metal or SiO₂, and the second bond includes a metal.

14. The LiDAR apparatus of claim 13, wherein the light modulator further comprises:
a through silicon via (TSV) electrode provided in an area of the substrate, corresponding to an area inside the circumference of the glass layer.

15. A method of manufacturing a spatial light modulator, the method comprising:
providing a first reflective layer on a substrate;
providing a cavity layer on the first reflective layer;
providing a second reflective layer on the cavity layer;
providing a grating structure on the second reflective layer;
forming a trench in a stack structure, the stack structure including the first reflective layer, the cavity layer, and the second reflective layer and providing at least one pixel; and
forming an opening on the substrate,
wherein each of pixels included in the spatial light modulator is supported by the substrate and are arranged to be separated from each other.

16. The method of claim 15,
wherein the forming of the trench in the stack structure includes:
sequentially etching the first reflective layer and the cavity layer until the substrate is exposed.

17. The method of claim 15, further comprising:
providing a glass layer on the substrate.

18. The method of claim 17,
wherein the providing of the glass layer on the substrate includes:
forming an anodic bond or an eutectic bond between the substrate and the glass layer.

19. The method of claim 15, further comprising
providing a protective layer on or below the substrate,
wherein the providing of the protective layer on or below the substrate includes:
forming an eutectic bond between the substrate and the protective layer.

20. The method of claim 15, further comprising, prior to the providing of the first reflective layer on the substrate:
forming a plurality of through silicon via (TSV) electrodes on the substrate.
